(19) United States
(12) Patent Application Publication
(10) Pub. No.: US 2010/0277554 A1
(43) Pub. Date: Nov. 4, 2010

(54) INK CARTRIDGE, ESPECIALLY FOR AN INK JET PRINTER

(75) Inventors: Daniel Sulser, Wald (CH); René Butty, Hinwil (CH)

Correspondence Address: MICHAEL BEST & FRIEDRICH LLP, 100 E WISCONSIN AVENUE, Suite 3300, MILWAUKEE, WI, 53202, US

(73) Assignee: PELIKAN HARDCOPY PRODUCTION AG, Egg (CH)

(21) Appl. No.: 12/743,761

(22) PCT Filed: Nov. 18, 2008
(86) PCT No.: PCT/EP08/65727

§ 371 Date: May 19, 2010

(30) Foreign Application Priority Data
Nov. 19, 2007 (DE) 102007055163.2

(51) Int. Cl. B41J 2/175

(52) U.S. Cl. 347/86

(57) ABSTRACT

An ink cartridge (10) having an ink reservoir which delimits in a first chamber (17) a free-ink volume (16) and in a second chamber (18) a capillary volume (15), the two chambers (17, 18) each being arranged to admit air by way of a respective opening (23, 24) and being in fluidic connection with one another by way of a passageway (22), and there being an ink outlet (21) associated with the chamber (18) delimiting the capillary volume (15). Capillary-increasing means (32) are associated with the passageway (22) between the two chambers (17, 18) on the side facing the capillary volume (15).

### RELATED APPLICATION DATA

This application claims priority from German Patent Application No. 102007055163.2, filed Nov. 19, 2007 and PCT Application No. PCT/EP2008/065727, filed Nov. 18, 2008, both of which are incorporated by reference herein.

### BACKGROUND

The present invention relates to an ink cartridge, especially for an inkjet printer, having an ink reservoir which delimits in a first chamber a free-ink volume and in a second chamber a capillary volume, the two chambers each being arranged to admit air by way of a respective opening and being in fluidic connection with one another by way of a passageway, and there being an ink outlet associated with the chamber delimiting the capillary volume.

Two-chamber ink cartridges of that kind are generally known. One chamber is used for holding liquid ink or so-called free-ink, while the other chamber delimits a capillary volume made of sponge material, fiber material or like storage material. The ink outlet to the printer, i.e. to a print head, is also associated with that chamber. Preferably, both ink chambers are arranged to admit air, that is to say to be connected to the external environment, by way of separate openings in order to bring about pressure equalization in and between the two chambers, which pressure equalization ensures operationally reliable use of the ink cartridge. The chamber delimiting the free-ink volume can be connected to the external environment especially by way of a bubble generator.

### SUMMARY

In each case it must be ensured, however, that no ambient air passes through the capillary volume and the passageway between the two chambers into the free-ink volume, because that would then considerably interfere with the admission of air to the chamber delimiting the free-ink volume, especially the operation of a bubble generator associated with that chamber, it being necessary to bear in mind that the admission of air to the two chambers must be co-ordinated in order finally to ensure complete emptying of the ink cartridge by way of the capillary volume.

Attempts have been made to solve this problem hitherto by making the material defining the capillary volume appreciably larger than when it is in the installed state. The material, for example sponge material or fiber material, defining the capillary volume is compressed into the associated chamber of the ink cartridge during assembly, so that the material fills all the corners and edges of the chamber. As a result, the penetration of ambient air into the chamber delimiting the free-ink volume is supposed to be prevented. If the sponge material or fiber material is not positioned very exactly, however, air channels of a greater or lesser size are formed, through which ambient air is able to pass into the fluid passageway between the two chambers and thus also into the chamber delimiting the free-ink volume. It is also conceivable for ambient air to find its way through a partially emptied capillary volume into the chamber delimiting the free-ink volume.

The present invention is based on the problem of providing an ink cartridge of the kind mentioned at the beginning which, in comparison with the prior art, provides considerably greater security against the penetration of ambient air through the chamber delimiting the capillary volume into the chamber delimiting the free-ink volume.

An important basic concept of the present invention therefore lies in arranging for the passageway between the two chambers to have, on the side facing the capillary volume, capillary-increasing means which define a kind of “air barrier”. In that way, it is ensured that, when the cartridge is in use, air is admitted to the chamber delimiting the free-ink volume in a predetermined way, that is to say in an operationally reliable way, by way of the air-admission opening associated with that chamber. In particular, it is thereby ensured that a bubble generator associated with the free-ink volume operates properly until the free-ink chamber has been fully emptied, so that the chamber delimiting the capillary volume can then be emptied without ambient air from the free-ink chamber being able to penetrate into the capillary volume through the fluidic connection between the two chambers. The chamber delimiting the capillary volume should take place by way of the air-admission opening associated with that chamber until emptying is complete. As a result of the measures according to the invention, therefore, the admission of air to the two chambers is to take place exclusively by way of the air-admission openings associated with those chambers, air being admitted to those chambers for the purpose of complete emptying of the cartridge, i.e. for the purpose of preset gradual emptying of the two chambers in a co-ordinated way. The co-ordinated admission of air is to be maintained from the first use of the cartridge until the cartridge has been completely emptied.

A preferred embodiment of the construction in accordance with the invention is characterized in that a rib extends around the fluid passageway between the two chambers on the side of the passageway associated with the capillary volume, which rib penetrates into the capillary volume, i.e. into the sponge material or fiber material defining the capillary volume. This effects local compression of the material defining the capillary volume, resulting in a corresponding increase in the capillarity in that region. That increased capillarity creates the desired “air barrier”.

As an alternative to the afore-mentioned rib construction it is also conceivable for the capillary volume to be provided with a capillary-increasing insert on the side facing the passageway between the two chambers, the insert extending around at least part of the passageway. In such an embodiment, the increase in capillary action is therefore brought about not by measures on the ink cartridge or the housing thereof, but by local modification of the material defining the capillary volume.

An especially preferred embodiment, which is also relatively simple from the manufacturing standpoint, is distinguished by the fact that the passageway is formed in a partition wall between the two chambers, starting from the base or the base wall of the cartridge, and that the rib projecting into the capillary volume is approximately U-shaped and delimits the passageway like a gateway. The limbs adjoining the base wall can then preferably be continued around the corner on the inner side, that is to say on the side facing the capillary volume, to form so-called base ribs.

Furthermore, it is conceivable for the passageway to be delimited by two or more ribs spaced apart from one another and extending parallel to one another, the height of those ribs in such an embodiment either being the same or, preferably, increasing in the direction towards the passageway. In that way, at least two “air barriers” around the fluid passageway between the two chambers are obtained.

A preferred embodiment of an ink cartridge constructed in accordance with the invention is described in greater detail below with reference to the accompanying drawing.

### BRIEF DESCRIPTION OF THE DRAWINGS

FIG. 1 shows a perspective view, obliquely from above, of an ink cartridge in which the features according to the invention have been implemented;

FIG. 2 shows the ink cartridge according to FIG. 1 in longitudinal section; and

FIG. 3 shows the ink cartridge according to FIG. 1 in a view corresponding to FIG. 1, but with the flat or longitudinal side wall broken away to show the features according to the invention.

### DETAILED DESCRIPTION

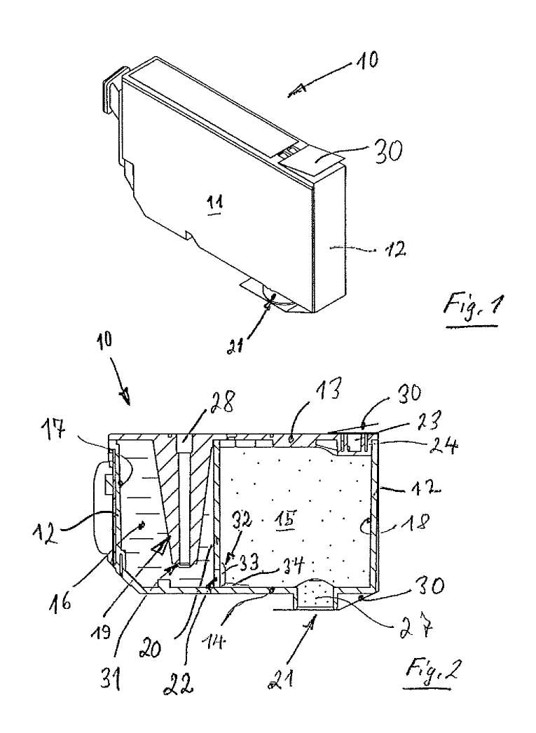

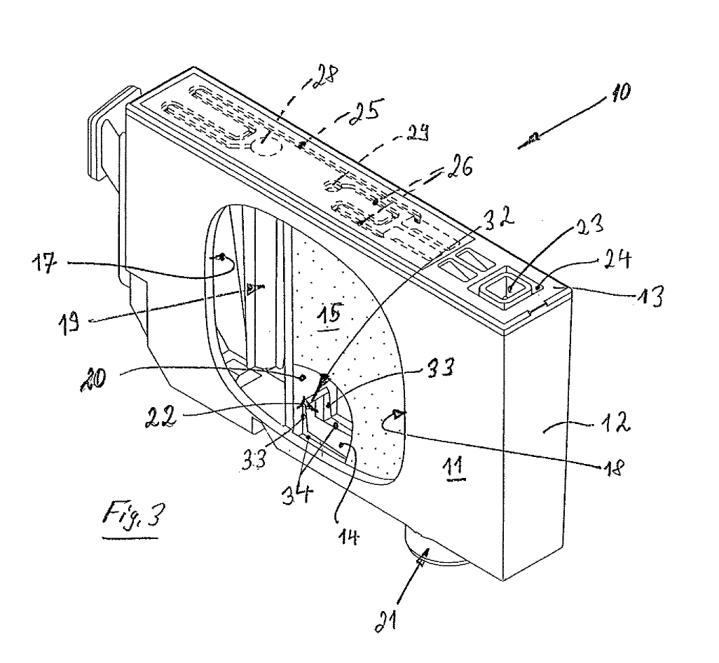

The ink cartridge shown in FIGS. 1 to 3 is indicated by reference numeral 10. It comprises two flat or longitudinal side walls 11 located opposite one another, two end side walls 12 located opposite one another, a top wall 13 and a base wall 14. Furthermore, the afore-mentioned ink cartridge has an ink reservoir which delimits in a first chamber 17 a free-ink volume 16 and in a second chamber 18 a capillary volume 15, the two chambers 17 and 18 each being arranged to admit air by way of a respective opening 23, 24 and being in fluidic connection with one another by way of a passageway 22. An ink outlet 21 is associated with the chamber 18 delimiting the capillary volume 15. The capillary volume 15 is formed by a storage element made of sponge material or fiber material. The ink outlet 21 is likewise arranged to have a sponge material or fiber material which has a higher capillarity than the capillary volume 15. That capillary element, sometimes also called a “wick”, associated with the ink outlet 21 is indicated by reference numeral 27 in FIG. 2.

As already mentioned, air-admission openings 23, 24 are associated with both chambers 17 and 18. The air-admission openings are arranged one inside the other in the embodiment shown. An inner air-admission opening 23 is connected by way of an air channel 25 formed in the top wall 13 to an opening 28 which leads into the chamber 17 delimiting the free-ink volume, which opening in turn communicates with a bubble generator 19 dipping into the free-ink volume. The central opening 23 is surrounded in a ring shape by an outer air-admission opening 24. The latter is connected by way of an air channel 26, which is likewise formed in the top wall 13, to an opening 29 which leads into the chamber 18 delimiting the capillary volume. Accordingly, air is admitted to both chambers 17 and 18 independently of one another once a so-called “remove film” 30 has been peeled off from the two openings 23, 24 prior to the first use of the cartridge 10. That remove film 30 also serves for covering the ink outlet 21 and is also peeled off there from prior to the first use of the cartridge 10.

As already mentioned, the opening 28 communicates with the so-called bubble generator 19 which is a dip tube dipping into the free-ink volume. At the lower, i.e. distal, end of that dip tube there is at least one slot-like opening through which, during use of the ink cartridge, air can be drawn into the chamber 17 as a result of the extraction of ink, forming air bubbles. The operation of the bubble generator 19 is very important for the complete emptying of the ink cartridge, and particularly for the gradual emptying thereof. It is first necessary to empty the chamber 17 delimiting the free-ink volume in order then to extract residual ink from the capillary volume.

The fluid passageway 22 between the two chambers 17 and 18, which passageway is formed at the base end of a partition wall 20 between the two afore-mentioned chambers, is arranged to have capillary-increasing means on the side facing the capillary volume 15, those means being in the form of a rib 32 surrounding the passageway 22 like a gateway (see FIGS. 2 and 3). The rib 32 projects into the capillary volume 15 and accordingly effects local compression thereof, that is to say of the sponge material or fiber material defining the capillary volume 15, resulting in increased capillarity, with the result that a corresponding air barrier is formed. In respect of the function of that air barrier, reference is made to the above comments in that connection. The rib 32 is therefore approximately U-shaped and directly adjoins the peripheral edge of the passageway 22. The limbs 33 of the rib 32 delimiting the passageway that adjoin the base wall 14 are continued around the corner on the inner side, that is to say on the side facing the capillary volume 15, to form so-called base ribs 34. Accordingly, the capillarity is increased in the afore-mentioned way around substantially all of the passageway 22.

In a preferred embodiment, starting from the passageway 22 the height of the base ribs 34 decreases continuously in the direction away from the passageway. A step-wise decrease in height is also conceivable.

The cross-section of the rib 32 delimiting the passageway 22 is preferably approximately semi-circular. It is conceivable, however, for the cross-section also to be triangular or trapezoidal. In principle, it is also conceivable for a transverse rib projecting into the capillary volume to be arranged at the lower end of the two limbs 33 of the U-shaped rib 32 that adjoin the inner side of the base wall 14, so that the passageway 22 is surrounded by the rib 32 in substantially the shape of a ring.

Instead of the rib 32 formed on the partition wall 20 and optionally on the inner side of the base wall 14 it is also conceivable to provide the capillary-increasing means on the material defining the capillary volume 15 or to provide that material with capillary-increasing means associated with the passageway 22 in a corresponding way. That can be effected by a capillary-increasing insert associated with the passageway 22 between the two chambers 17 and 18, which insert extends at least partly around the passageway 22 and is defined by a material of relatively high density, i.e. relatively small pore size.

All the features disclosed in the application documents are claimed as being important to the invention to the extent that they are novel individually or in combination with respect to the prior art.

1-10. (canceled)

11. An ink cartridge (10) configured for use with an inkjet printer, the ink cartridge comprising:
an ink reservoir which delimits in a first chamber (17) a free-ink volume (16) and in a second chamber (18) a capillary volume (15), the two chambers (17, 18) each being arranged to admit air by way of a respective opening (23, 24) and being in fluidic connection with one another by way of a passageway (22); and
an ink outlet (21) associated with the second chamber (18) delimiting the capillary volume (15),
wherein the passageway (22) between the first chamber and the second chamber (17, 18) is delimited by capillary-increasing means (32) on a side of the passageway facing the capillary volume (15).

12. The ink cartridge according to claim 11, wherein the capillary-increasing means comprise at least one rib (32) extending at least partly around the passageway (22).

13. The ink cartridge according to claim 12, wherein the passageway (22) is formed in a partition wall (20) between the first chamber and the second chamber, the partition wall starting from a base wall (14) of the ink cartridge (10), and wherein the at least one rib (32) projecting into the capillary volume (15) is approximately U-shaped and delimits the passageway (22) like a gateway.

14. The ink cartridge according to claim 13, wherein limbs (33) of the at least one rib (32) delimit the passageway (22) and the limbs that adjoin the base wall (14) are continued around a corner of the passageway on a inner side of the passageway to form base ribs (34).

15. The ink cartridge according to claim 12, wherein the cross-section of the at least one rib (32) delimiting the passageway (22) is one of triangular, trapezoidal and semi-circular.

16. The ink cartridge according to claim 12, wherein the passageway (22) is delimited by at least two ribs spaced apart from one another and extending parallel to one another, the height of the at least two ribs being one of the same and increasing in a direction towards the passageway (22).

17. The ink cartridge according to claim 14, wherein starting from the passageway (22), a height of the base ribs (34) decreases continuously in a direction away from the passageway.

18. The ink cartridge according to claim 11, wherein the capillary volume (15) comprises on the side facing the passageway (22) between the first chamber and the second chamber (17, 18) a capillary-increasing insert which extends around at least part of the passageway (22) and delimits the passageway.

19. The ink cartridge according to claim 18, wherein the capillary-increasing insert is formed by a material of higher density and having a smaller pore size in comparison with the remainder of the capillary volume.

20. The ink cartridge according to claim 14, wherein the base ribs (34) include free ends, and wherein the free ends are connected to one another by means of a transverse rib.
